(19) United States
(12) Patent Application Publication
(10) Pub. No.: US 2022/0198225 A1
(43) Pub. Date: Jun. 23, 2022

(54) METHOD AND SYSTEM FOR DETERMINING ACTION OF DEVICE FOR GIVEN STATE USING MODEL TRAINED BASED ON RISK-MEASURE PARAMETER

(71) Applicants: NAVER CORPORATION, Gyeonggi-do (KR); NAVER LABS CORPORATION, Seongnam-si (KR)

(72) Inventors: Jinyoung CHOI, Seongnam-si (KR); Christopher Roger DANCE, Seongnam-si (KR); Jung-eun KIM, Seongnam-si (KR); Seulbin HWANG, Seongnam-si (KR); Kay PARK, Seongnam-si (KR)

(73) Assignees: NAVER CORPORATION, Gyeonggi-do (KR); NAVER LABS CORPORATION, Seongnam-si (KR)

(21) Appl. No.: 17/518,695

(22) Filed: Nov. 4, 2021

(30) Foreign Application Priority Data
Dec. 23, 2020 (KR) 10-2020-0181547

(51) Int. Cl. G06K 9/62; G06F 17/18; G06N 20/00

(52) U.S. Cl. CPC G06K 9/6262; G06N 20/00; G06F 17/18; G06K 9/6256

(57) ABSTRACT

A method of determining an action of a device for a given situation, implemented by a computer system, includes for a learning model that learns a distribution of rewards according to the action of the device for the situation using a risk-measure parameter associated with control of the device, selectively setting a value of the risk-measure parameter in accordance with an environment in which the device is controlled; and determining the action of the device for the given situation when controlling the device in the environment, based on the set value of the risk-measure parameter.

### CROSS-REFERENCE TO RELATED APPLICATION(S)

This U.S. non-provisional application and claims the benefit of priority under 35 U.S.C. § 365(c) to Korean Patent Application No. 10-2020-0181547, filed Dec. 23, 2020, the entire contents of which are incorporated herein by reference in their entirety.

### BACKGROUND

### 1. Field

One or more example embodiments relate to a method of determining an action of a device for a situation and, more particularly, to a method of determining an action of a device for a situation through a model that learns a distribution of rewards according to the action of the device using a risk-measure parameter associated with control of the device and a method of training the corresponding model.

### 2. Related Art

Reinforcement learning refers to a type of machine learning and is a learning method for selecting an optimal action for a given situation or state. A computer program subjected to reinforcement learning may be called an agent. The agent may establish a policy indicating an action for the agent to take for a given situation and may train a model to establish the policy that allows the agent to obtain a maximum reward. Such reinforcement learning may be used to implement an algorithm for an autonomous driving vehicle or an autonomous driving robot.

An example application of such technology is an autonomously traveling robot that may recognize absolute coordinates and automatically move to a goal position and a navigation method thereof.

The aforementioned information is provided to assist understanding only and may contain content that does not form a portion of the related art.

### SUMMARY

One or more example embodiments provide a model learning method that may learn a distribution of rewards according to an action of a device for a situation using a risk-measure parameter associated with control of the device.

One or more example embodiments provide a method of setting a risk-measure parameter according to a characteristic of an environment for a learning model that learns a distribution of rewards according to an action of a device for a situation using the risk-measure parameter and may determine the action of the device for the given situation when controlling the device in the corresponding environment.

According to at least some example embodiments, a method of determining an action of a device for a given situation, implemented by a computer system, includes for a learning model that learns a distribution of rewards according to the action of the device for the situation using a risk-measure parameter associated with control of the device, selectively setting a value of the risk-measure parameter in accordance with an environment in which the device is controlled; and determining the action of the device for the given situation when controlling the device in the environment, based on the set value of the risk-measure parameter.

The determining of the action of the device may include determining the action of the device to be more risk-averse or risk-seeking for the given situation based on the set value of the risk-measure parameter or a range indicated by the set value of the risk-measure parameter.

The device may be an autonomous driving robot, and the determining of the action of the device may include determining run-forward or acceleration of the robot as a more risk-seeking action of the robot if the value of the risk-measure parameter is greater than or equal to a desired value or if the set value of the risk-measure parameter is greater than or equal to a desired range.

The device may be an autonomous driving robot, and the determining of the action of the device may include selecting, as the determined action, an action that causes the device to operate in a more risk-seeking manner as the set value of the risk-measure parameter becomes a more risk-seeking value, and selecting, as the determined action, an action that causes the device to operate in a more risk-averse manner as the set value of the risk-measure parameter becomes a more risk-averse value.

The learning model may learn the distribution of rewards obtainable according to the action of the device for the situation using a quantile regression method.

The learning model may learn values of the rewards corresponding to first parameter values that belong to a first range, sample the risk-measure parameter that belongs to a second range corresponding to the first range and learn a value of a reward corresponding to the sampled risk-measure parameter in the distribution of rewards, and a minimum value among the first parameter values may correspond to a minimum value among the values of the rewards and a maximum value among the first parameter values may correspond to a maximum value among the values of the rewards.

The first range may be 0-1 and the second range may be 0-1, and the risk-measure parameter belonging to the second range may be randomly sampled at a time of learning of the learning model.

Each of the first parameter values may represent a percentage position, and each of the first parameter values may correspond to a value of a corresponding reward at a corresponding percentage position.

The learning model may include a first model configured to predict the action of the device for the situation; and a second model configured to predict a reward according to the predicted action, wherein each of the first model and the second model may be trained using the risk-measure parameter, and wherein the first model may be trained to predict an action that maximizes the reward predicted from the second model as a next action of the device.

The device may be an autonomous driving robot, and the first model and the second model may be configured to predict the action of the device and the reward, respectively, based on a position of an obstacle around the robot, a path through which the robot is to move, and a velocity of the robot.

The learning model may learn the distribution of rewards by iterating estimating of the reward according to the action of the device for the situation, each iteration may include learning each episode that represents a movement from a start position to a goal position of the device and updating the learning model, and, when each episode starts, the risk-measure parameter may be sampled and the sampled risk-measure parameter may be fixed until a corresponding episode ends.

Updating of the learning model may be performed using the sampled risk-measure parameter that is stored in a buffer, or performed by resampling the risk-measure parameter and using the resampled risk-measure parameter.

The risk-measure parameter may be a parameter representing a conditional value-at-risk (CVaR) risk measure that is a number within a range greater than 0 and less than or equal to 1, or a power-law risk measure that is a number within the range less than zero.

The device may be an autonomous driving robot, and the setting of the risk-measure parameter may include setting the value of the risk-measure parameter to the learning model based on a value requested by a user while the robot is autonomously driving in the environment.

According to at least some example embodiments, a non-transitory computer-readable record medium stores computer-executable instructions that, when executed by a processor, cause the processor to perform the method.

According to at least some example embodiments, a computer system includes memory storing computer-executable instructions; at least one processor configured to execute the computer-executable instructions such that the at least one processor is configured to, for a learning model that learns a distribution of rewards according to an action of a device for a situation using a risk-measure parameter associated with control of the device, selectively set a value of the risk-measure parameter in accordance with an environment in which the device is controlled, and determine the action of the device for the situation when controlling the device in the environment, based on the set value of the risk-measure parameter.

According to at least some example embodiments, a method of training a model used to determine an action of a device for a situation includes training, by a processor, the model to learn a distribution of rewards according to the action of the device for the situation using a risk-measure parameter associated with control of the device such that the trained model includes a risk-measure parameter that is capable of being selectively set according to a characteristic of an environment, and as the risk-measure parameter of the trained model is set for the environment in which the device is controlled, the trained model determines the action of the device for the situation based on the set risk-measure parameter through the model when the device is being controlled in the environment.

The training may include training the model to learn the distribution of rewards obtainable according to the action of the device for the situation using a quantile regression method.

The training may include training the model to learn values of the rewards corresponding to first parameter values that belong to a first range, sampling the risk-measure parameter that belongs to a second range corresponding to the first range; and learning a value of a reward corresponding to the sampled risk-measure parameter in the distribution of rewards, and a minimum value among the first parameter values may correspond to a minimum value among the values of the rewards and a maximum value among the first parameter values may correspond to a maximum value among the values of the rewards.

The trained model may include a first model configured to predict the action of the device for the situation; and a second model configured to predict a reward according to the predicted action, wherein each of the first model and the second model may be trained using the risk-measure parameter, and wherein the training may include training the first model to predict an action that maximizes the reward predicted from the second model as a next action of the device.

According to some example embodiments, when determining an action of a device including a robot that grasps an object and an autonomous driving robot for a situation, it is possible to use a model that learns a distribution of rewards according to the action of the device using a risk-measure parameter associated with control of the corresponding device.

According to some example embodiments, it is possible to set various risk-measure parameters to a model without retraining the model.

According to some example embodiments, since a risk-measure parameter considering a characteristic of an environment is settable to a model, a device may be controlled in a risk-averse or risk-seeking manner considering a characteristic of a given environment using the model to which such risk-measure parameter is set.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a diagram illustrating an example of a computer system to perform a method of determining an action of a device for a situation according to at least one example embodiment;

FIG. 2 is a diagram illustrating an example of a processor of a computer system according to at least one example embodiment;

FIG. 3 is a flowchart illustrating an example of a method of determining an action of a device for a situation according to at least one example embodiment;

FIG. 4 is a graph showing an example of a distribution of rewards according to an action of a device learned by a learning model according to at least one example embodiment;

FIG. 5 illustrates an example of a robot controlled in an environment based on a set risk-measure parameter according to at least one example embodiment;

FIG. 6 illustrates an example of an architecture of a model to determine an action of a device for a situation according to at least one example embodiment;

FIG. 7 illustrates an example of an environment of a simulation for training a learning model according to at least one example embodiment; and

FIGS. 8A and 8B illustrate examples of setting a sensor of a robot in a simulation for training a learning model according to at least one example embodiment.

### DETAILED DESCRIPTION

One or more example embodiments will be described in detail with reference to the accompanying drawings. Example embodiments, however, may be specified in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

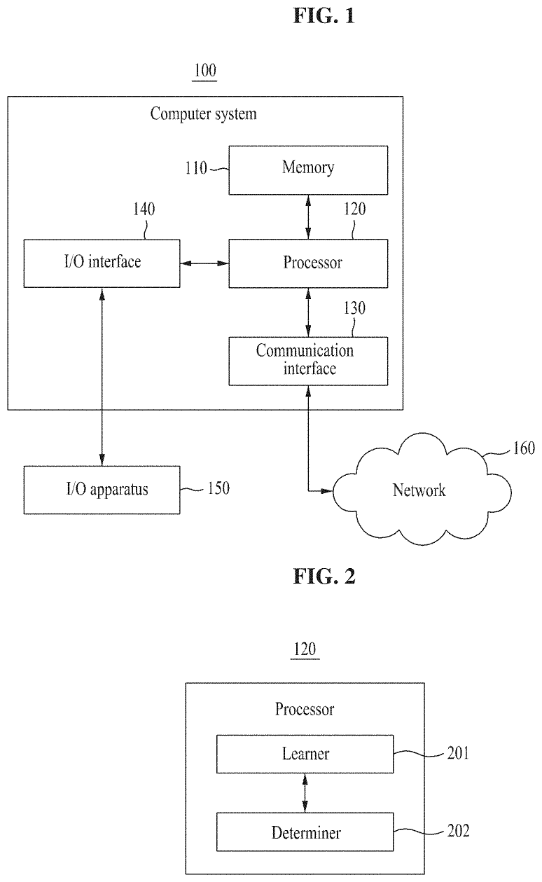

FIG. 1 is a diagram illustrating an example of a computer system to perform a method of determining an action of a device for a situation according to at least one example embodiment.

A computer system to perform the method of determining an action of a device for a situation according to the following example embodiments may be implemented by a computer system 100 of FIG. 1.

The computer system 100 may be a system configured to build a model to determine an action of a device for a situation, which is described below. The built model may be provided to the computer system 100. Through the computer system 100, the built model may be provided to an agent that is a program for control of the device. Alternatively, the computer system 100 may be included in the device. That is, the computer system 100 may constitute a control system of the device.

The device may refer to a device that performs a specific action, that is, a control operation for a given situation (state). The device may be, for example, an autonomous driving robot. Alternatively, the device may be a service robot that provides a service. The service provided from the service robot may include a delivery service that delivers food, a product, or goods in the space or a route guidance service that guides a user to a specific position in the space. Alternatively, the device may be a robot that performs an operation of grasping or picking up an object. In addition, any device capable of performing a specific control operation according to a given situation (state) may be a device of which an action is determined using a model of an example embodiment. The control operation may refer to any device operation controllable according to a reinforcement learning-based algorithm.

The term “situation (state)” may represent a situation that a controlled device faces in an environment. For example, if the device is an autonomous driving robot, the “situation (state)” may represent any situation that the autonomous driving robot encounters with moving from a starting position to a goal position (e.g., a situation in which an obstacle is present in front or around).

Referring to FIG. 1, the computer system 100 may include a memory 110, a processor 120, a communication interface 130, and an input/output (I/O) interface 140 as components.

The memory 110 may include a permanent mass storage device, such as a random access memory (RAM), a read only memory (ROM), and a disk drive, as a computer-readable record medium. The permanent mass storage device, such as a ROM and a disk drive, may be included in the computer system 100 as a permanent storage device separate from the memory 110. Also, an OS and at least one program code may be stored in the memory 110. Such software components may be loaded to the memory 110 from another computer-readable record medium separate from the memory 110. The other computer-readable record medium may include a computer-readable record medium, for example, a floppy drive, a disk, a tape, a DVD/CD-ROM drive, a memory card, etc. According to other example embodiments, software components may be loaded to the memory 110 through the communication interface 130, instead of the computer-readable record medium. For example, the software components may be loaded to the memory 110 of the computer system 100 based on a computer program installed by files provided over a network 160.

The processor 120 may be configured to process instructions of a computer program by performing basic arithmetic operations, logic operations, and I/O operations. The instructions may be provided from the memory 110 or the communication interface 130 to the processor 120. For example, the processor 120 may be configured to execute received instructions in response to the program code stored in the storage device, such as the memory 110.

The communication interface 130 may provide a function for communication between the computer system 100 and other apparatuses over the network 160. For example, the processor 120 of the computer system 100 may transfer a request or an instruction created based on a program code stored in the storage device such as the memory 110, data, a file, etc., to the other apparatuses over the network 160 under control of the communication interface 130. Inversely, a signal, an instruction, data, a file, etc., from another apparatus may be received at the computer system 100 through the communication interface 130 of the computer system 100. For example, a signal, an instruction, data, etc., received through the communication interface 130 may be transferred to the processor 120 or the memory 610, and a file, etc., may be stored in a storage medium, for example, the permanent storage device, further includable in the computer system 100.

The communication scheme through the communication interface 130 is not particularly limited and may include a communication method using a near field communication between devices as well as a communication method using a communication network (e.g., a mobile communication network, the wired Internet, the wireless Internet, a broadcasting network, etc.) which may be included in the network 160. For example, the network 160 may include at least one of network topologies that include, for example, a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, a tree or hierarchical network, and the like. However, it is provided as an example only and the example embodiments are not limited thereto.

The I/O interface 140 may be a device used for interface with an I/O apparatus 150. For example, an input device may include a device, such as a microphone, a keyboard, a camera, a mouse, etc., and an output device may include a device, such as a display, a speaker, etc. As another example, the I/O interface 140 may be a device for interface with an apparatus in which an input function and an output function are integrated into a single function, such as a touchscreen. The I/O apparatus 150 may be configured as a single apparatus with the computer system 100.

Also, according to other example embodiments, the computer system 100 may include a number of components less than or greater than the number of components of FIG. 1. However, there is no need to clearly illustrate many components according to the related art. For example, the computer system 100 may be configured to include at least a portion of the I/O apparatus 150 or may further include other components, for example, a transceiver and a database.

Hereinafter, the processor 120 of the computer system 100 that performs a method of determining an action of a device for a situation according to an example embodiment and builds a model trained to determine the action of the device for the situation is further described.

FIG. 2 is a diagram illustrating an example of a processor of a computer system according to at least one example embodiment.

Referring to FIG. 2, the processor 120 may include a learner 201 and a determiner 202. The components of the processor 120 may be representations of different functions performed by the processor 120 in response to a control instruction provided from at least one program code. For example, according to at least some example embodiments, the memory 110 may store program code including computer-executable instructions that, when executed by the processor 120, cause the processor 120 to implement one or both of the learner 201 and determiner 202.

For example, the learner 201 may be used as a functional representation of an operation of the processor 120 for learning (training) of the model used to determine the action of the device for the situation according to the example embodiment, and the determiner 202 may be used as a functional representation of an operation of the processor 120 to determine the action of the device for the given situation using the trained model.

The processor 120 and the components of the processor 120 may perform operations 310 to 330 of FIG. 3. For example, the processor 120 and the components of the processor 120 may be configured to execute an instruction according to at least one program code and a code of an OS included in the memory 110. Here, at least one program code may correspond to a code of a program configured to process an autonomous driving learning method.

The processor 120 may load, to the memory 110, a program code stored in a program file for performing the method. The program file may be stored in a permanent storage device separate from the memory 110 and the processor 120 may control the computer system 100 such that the program code may be loaded from the program file stored in the permanent storage device to the memory 110 through a bus. Here, the components of the processor 120 may perform an operation corresponding to operations 310 to 330 by executing an instruction of a portion corresponding to the program code loaded to the memory 110. To perform the following operations including operations 310 to 330, the components of the processor 120 may process an operation according to a direct control instruction or may control the computer system 100.

In the following detailed description, an operation performed by the computer system 100, the processor 120, or the components of the processor 120 may be explained, for clarity of description, as an operation performed by the computer system 100.

FIG. 3 is a flowchart illustrating an example of a method of determining an action of a device for a situation according to at least one example embodiment.

Hereinafter, a method of training a model, for example, a learning model used to determine an action of a device for a situation and determining the action of the device for the situation using the trained model is further described with reference to FIG. 3.

Referring to FIG. 3, in operation 310, the computer system 100 may train a model used to determine an action of a device for a situation. Here, the model may be a model trained using a deep reinforcement learning (DRL)-based algorithm. The computer system 100 may train the model for determining the action of the device to learn a distribution of rewards according to the action of the device for the situation using a risk-measure parameter associated with control of the device. Herein, the terms “situation” and “state” may be interchangeably used, and the term “risk-measure parameter” may refer to a parameter that represents a risk measure.

In operation 320, the computer system 100 may set the risk-measure parameter for an environment in which the device is controlled using the risk-measure parameter associated with control of the device. In an example embodiment, the risk-measure parameter may be differently (e.g., selectively) set to the learning model according to a characteristic of the environment in which the device is controlled. Here, setting of the risk-measure parameter to the built learning model may be performed by a user that operates the device to which the corresponding learning model is applied. For example, the user may set the risk-measure parameter to be considered when the device is controlled in the environment, through a user interface of a user terminal or the device used by the user. When the device is an autonomous driving robot, the risk-measure parameter may be set to the learning model based on a value requested by the user while the robot autonomously drives in the robot, or before or after autonomous driving of the robot in the environment. Here, the set risk-measure parameter may consider a characteristic of the environment in which the device is controlled.

For example, when the environment in which the device, i.e., the autonomous driving robot is a place in which an obstacle or a pedestrian is highly likely to appear, the user may set a parameter corresponding to a more risk-averse value to the learning model. Alternatively, when the environment in which the device, i.e., the autonomous driving robot is controlled is a place in which an obstacle or a pedestrian is less likely to appear and of which a passage for driving of the robot is wide, the user may set a parameter corresponding to a more risk-seeking value to the learning model.

In operation 330, the computer system 100 may determine the action of the device for the given situation when controlling the device in the environment, based on the set risk-measure parameter, i.e., based on a result value by the learning model based on the set risk-measure parameter. That is, the computer system 100 may control the device in consideration of a risk measure according to the set risk-measure parameter. Accordingly, the device may be controlled to be risk-averse for an encountered situation (e.g., drive another passage without an obstacle or significantly slow down and avoid the obstacle when encountering the obstacle in a passage), or may also be controlled to be risk-seeking for the encountered situation (e.g., pass through a passage with an obstacle as is or pass through a narrow passage without slowing down).

The computer system 100 may determine the action of the device to be more risk-averse or more risk-seeking for the given situation base on a value of the set risk-measure parameter or a range indicated by the value of the risk-measure parameter (e.g., less than or equal to/less than a corresponding parameter value). That is, the value or the range of the set risk-measure parameter may correspond to a risk measure considered by the device in controlling of the device.

In an example in which the device is an autonomous driving robot, the computer system 100 may determine run-forward or acceleration of the robot as a more risk-seeking action of the robot if the value of the risk-measure parameter for the learning model is greater than or equal to a desired value or if the value of the parameter is greater than or equal to a desired range. On the contrary, a less risk-seeking action of the robot, that is, a risk-averse action of the robot may be detouring to another passage or deceleration of the robot.

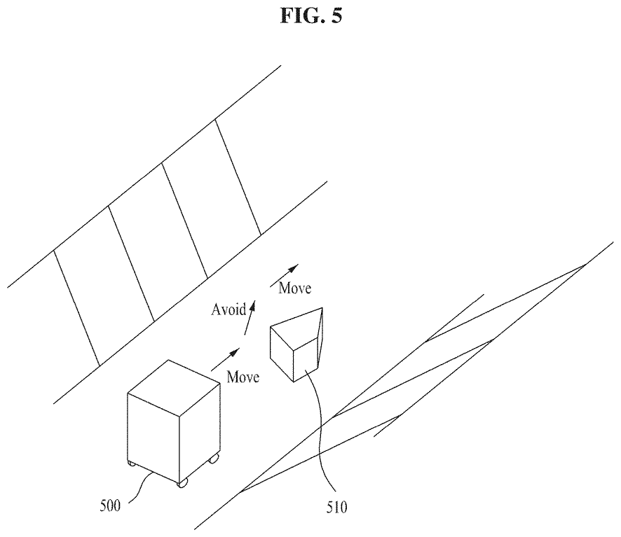

Here, FIG. 5 illustrates an example of a robot controlled in an environment based on a set risk-measure parameter according to at least one example embodiment. A robot 500 of FIG. 5 may be an autonomous driving robot and may correspond to the aforementioned device. Referring to FIG. 5, in a situation in which the robot 500 encounters an obstacle 510, the robot 500 may move avoiding the obstacle 510. As described above, an action of the robot 500 to avoid the obstacle 510 may be differently performed according to a risk-measure parameter set to a learning model used to control the robot 500.

Meanwhile, if the device is a robot that grasps or picks up an object, a more risk-seeking action of the robot may be an action of more daringly grasping the object, for example, with a higher velocity and/or a greater force. Conversely, a less risk-seeking action of the robot may be an action of more carefully grasping an object, for example, with a lower velocity and/or a less force.

Alternatively, if the device is a robot with a leg(s), a more risk-seeking action of the robot may be a more drastic action, for example, an action with a larger stride or a faster velocity. Conversely, a less risk-seeking action of the robot may be a more cautious action, for example, an action with a smaller stride and/or a slower pace.

As described above, in an example embodiment, a risk-measure parameter considering a characteristic of an environment in which a device is controlled may be variously set to a learning model, that is, using various different values). The device may be controlled by considering a risk measure suitable for the environment.

The learning model of the example embodiment may learn a distribution of rewards according to the action of the device using the risk-measure parameter during an initial learning. When setting the risk-measure parameter to the learning model, there is no need to train the learning model every time the risk-measure parameter is reset.

Hereinafter, a method of training a learning model to learn a distribution of rewards according to an action of a device using a risk-measure parameter is further described.

When the device performs an action for a situation, that is, a state, the learning model may learn a reward obtained according to the action. The reward may be a cumulative reward obtained by performing the action. For example, if the device is an autonomous driving robot that moves from a start position to a goal position, the cumulative reward may refer to a cumulative reward obtained according to an action of the robot until the robot reaches the goal position. The learning model may learn rewards obtained according to an action of the device for a situation, iterated a plurality of times, for example, a million times. Here, the learning model may learn a distribution of rewards obtained according to the action of the device for the situation. The distribution of rewards may represent a probability distribution.

For example, the learning model of the example embodiment may learn a distribution of rewards, for example, cumulative rewards obtainable according to an action of the device for the situation using a quantile regression method.

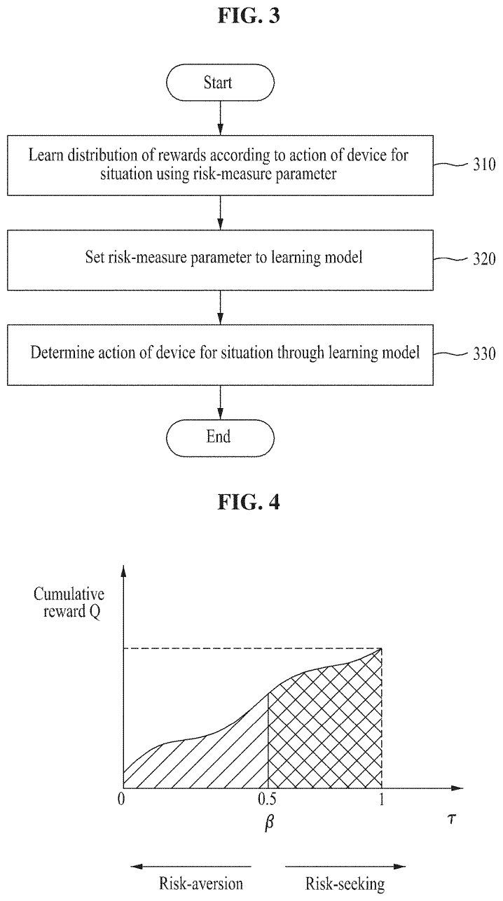

FIG. 4 is a graph showing an example of a distribution of rewards according to an action of a device learned by a learning model according to at least one example embodiment. FIG. 4 may represent a distribution of rewards learned by the learning model according to a quantile regression method.

When an action (a) is performed for a situation (s), a reward (Q) may be given. Here, the more appropriate the action, the higher the reward may be. The learning model may learn a distribution for such reward.

Rewards obtainable when the device performs an action for a situation may include a maximum value and a minimum value. The maximum value may refer to a cumulative reward when the action of the device is most positive among a large number of iterations, for example, a million times, and the minimum value may refer to a cumulative reward when the action of the device is most negative among the large number of iterations. Each of rewards from the minimum value to the maximum value may be listed to correspond to a quantile. For example, for a quantile of 0 to 1, a value of a reward corresponding to a minimum value (e.g., a million) may correspond to 0, a value of a reward corresponding to a maximum value (e.g., 1) may correspond to 1, and a value of a reward corresponding to a middle (e.g., 500,000) may correspond to 0.5. The learning model may learn a distribution of rewards. Therefore, a value of a reward Q corresponding to a quantile τ may be learned.

That is, the learning model may learn values of rewards (corresponding to Q of FIG. 4) corresponding to first parameter values (corresponding to τ of FIG. 4 as a quantile) (e.g., based on a one-to-one correspondence) belonging to a first range. Here, a minimum value (e.g., 0 in FIG. 4) among first parameter values may correspond to a minimum value among values of rewards and a maximum value (e.g., 1 in FIG. 4) among the first parameter values may correspond to a maximum value among the values of the rewards. Also, in learning the distribution of rewards, the learning model may also learn a risk-measure parameter. For example, the learning model may sample a risk-measure parameter (corresponding to [symbol] of FIG. 4) that belongs to a second range corresponding to the first range and may learn a value of a reward corresponding to the sampled risk-measure parameter in the distribution of rewards. That is, in learning the distribution of rewards shown in FIG. 4, the learning model may further consider the sampled parameter representing risk measure (e.g., [symbol] =0.5) and may learn a value of a reward corresponding thereto.

The value of the reward corresponding to the risk-measure parameter (e.g., [symbol] =0.5) may be a value of a reward corresponding to a first parameter (e.g., τ=0.5) identical to the corresponding parameter. Alternatively, the value of the reward corresponding to the risk-measure parameter (e.g., [symbol] =0.5) may be an average value of rewards corresponding to the first parameter (e.g., τ=0.5) identical to the corresponding parameter or less.

Referring to FIG. 4, for example, a first range of a first parameter corresponding to τ may be 0˜1 and a second range of a risk-measure parameter may be 0˜1. Each of first parameter values may represent a percentage position and each of the first parameter values may correspond to a value of a corresponding reward at a corresponding percentage position. That is, the learning model may be trained to predict a reward that is obtained by inputting a situation, an action for the situation, and a top % value.

Although FIG. 4 illustrates that the second range is identical to the first range as an example, the second range may differ from the first range. For example, the second range may be less than 0. For learning of the learning model, the risk-measure parameter that belongs to the second range may be randomly sampled.

Meanwhile, in FIG. 4, Q may be normalized to a value of 0˜1.

That is, in an example embodiment, in the case of learning a distribution of rewards shown in FIG. 4, sampled [symbol] may be fixed and thereby learned. Therefore, a risk-measure parameter ( [symbol] ) considering a characteristic of an environment in which the device is controlled may be variously reset to the trained model (for control of the device in consideration of a risk measure suitable for the environment). Compared to a case of learning the average of rewards obtained according to a simple action or learning only the distribution of rewards without considering the risk-measure parameter ( [symbol] ), the example embodiment may not require an operation of retraining the learning model when resetting the risk-measure parameter ( [symbol] ).

Referring to FIG. 4, as [symbol] increase (i.e., closer to 1), the device may be controlled to be more risk-seeking. As [symbol] decreases (i.e., closer to 0), the device may be controlled to be risk-averse. By setting, by the user that operates the device, [symbol] to be suitable for the learning model, the device may be controlled to be more risk-averse or less risk-averse. If the device is an autonomous driving robot, the user may apply a value of [symbol] to the learning model for controlling the device before or after driving of the robot and may change and set the value of [symbol] to change a risk measure considered by the robot even while the robot is driving.

For example, if [symbol] is set as 0.9 to the learning model, the device being controlled may act with the prediction of obtaining a top 10% reward at all times and thus may be controlled in a more risk-seeking direction. Conversely, if [symbol] is set as 0.1 to the learning model, the device being controlled may act with the prediction of obtaining a bottom 10% reward at all times and thus may be controlled in a more risk-averse direction.

In an example embodiment, when determining an action of a device, a parameter related to a positive or negative level of prediction for a risk may be additionally set, for example, in real time, and the device may be implemented to further sensitively respond to the risk. This may ensure safer driving of the device in a situation in which a corresponding environment is partially observable due to a limitation in a viewing angle of a sensor included in the device.

In an example embodiment, the risk-measure parameter ( [symbol] ) may be a parameter that distorts a probability distribution (i.e., a reward distribution). [symbol] may be defined as a parameter for distorting the probability distribution (i.e., a (probability) distribution of rewards obtained according to an action of the device) to be more risk-seeking or more risk-averse depending on a value of [symbol] . That is, [symbol] may be a parameter for distorting the probability distribution of rewards learned in correspondence to the first parameter (τ). In an example embodiment, the distribution of rewards obtainable by the device may be distorted based on variably settable [symbol] and the device may operate in a more negative direction or in a more positive direction based on [symbol] .

Description related to technical features made above with reference to FIGS. 1 and 2 may apply to FIGS. 3 to 5 and thus, further description is omitted.

Hereinafter, the aforementioned learning model implemented by the computer system 100 is further described with reference to FIGS. 5 to 8B.

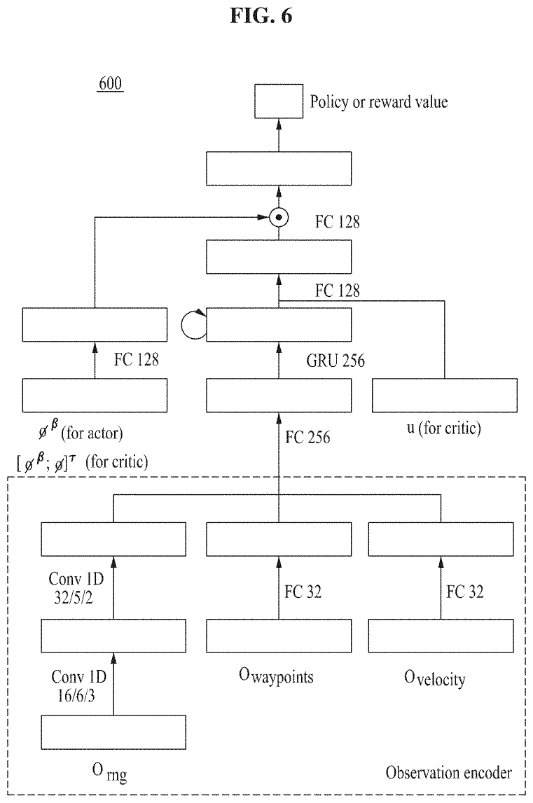

FIG. 6 illustrates an example of an architecture of a model to determine an action of a device for a situation according to at least one example embodiment.

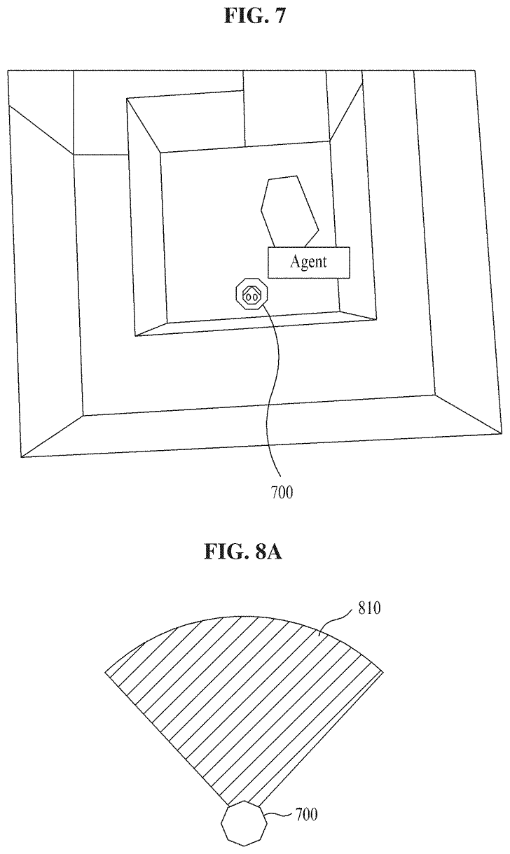

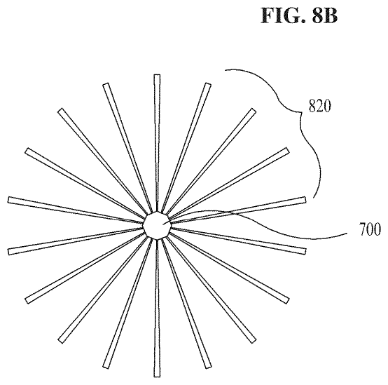

FIG. 7 illustrates an example of an environment of a simulation for training a learning model according to at least one example embodiment, and FIGS. 8A and 8B illustrate examples of setting a sensor of a robot in a simulation for training a learning model according to at least one example embodiment.

The aforementioned learning model may refer to a model for a risk-sensitive navigation of a device and may be a model built based on a risk-conditioned distributional soft actor-critic (RC-DSAC) algorithm.

Current navigation algorithms based on deep reinforcement learning (RL) show promising efficiency and robustness, however, many deep RL algorithms operate in a risk-neutral manner and make no special attempt to shield a user from an action that may lead to relatively rare but serious outcomes, although such shielding causes little loss of performance. In addition, such algorithms operate typically make no provisions to ensure safety in the presence of inaccuracies in a model on which the algorithms are trained, beyond adding a cost-of-collision and some domain randomization while training, in spite of significant complexity of environments in which the algorithms.

Herein, the RC-DSAC algorithm may be provided as a novel distributional RL algorithm that may learn an uncertainty-aware policy and may also change its risk measure without expensive fine-tuning or retraining. A method according to the algorithm presented herein may demonstrate superior performance and safety over baselines in partially observed navigation tasks. Also, agents trained using the method of the example embodiment may demonstrate that an appropriate policy (i.e., action) may be adapted to a wide range of risk measures at run-time.

Hereinafter, an outline for building a model based on the RC-DSAC algorithm is described.

Deep reinforcement learning (RL) is attracting considerable interest in the field of a mobile robot navigation due to its promise of superior performance and robustness compared to existing planning-based algorithms. Despite this interest, few existing works on DRL-based navigation attempt to design risk-averse policies, which may be resulted from the following reasons. First, a driving, i.e., navigating robot may cause a harm to a human, to another robot, to the robot itself, or to surroundings, and risk-averse polices may be safer than risk-neutral policies, while avoiding over-conservative behavior typical of policies based on worst-case analyses. Second, in environments with a complex structure and dynamics in which it is impractical to provide accurate models, policies optimizing specific risk measures may be an appropriate choice since the polices actually provide guarantees on robustness to modelling errors. Third, since end-users, insurers, and designers of navigation agents are risk-averse humans, the risk-averse policies may be a natural choice.

To overcome the issue of risk found in RL, the concept of distributional RL may be introduced. The distributional RL refers to learning a distribution of accumulated rewards rather than simply learning the mean of the distribution of rewards. By applying an appropriate risk measure that is simply a mapping from the distribution of rewards to a real number, distributional RL algorithms may infer risk-averse polices or risk-seeking policies. The distributional RL may represent superior efficiency and performance on arcade games, simulated robotics benchmarks, and real-world grasping tasks. Also, for example, although a risk-averse policy may be preferred in one environment to avoid a scaring pedestrian, the policy may be too risk-averse to pass through a narrow passage. Therefore, there is a need to train a model to have different risk measures suitable for the respective environments, which may be a computationally expensive and time-consuming task.

Herein, an RC-DSAC algorithm that learns a wide range of risk-sensitive policies concurrently may be provided to efficiently train an agent that may adapt to a plurality of risk measures.

The RC-DSAC algorithm may demonstrate superior performance and safety compared to non-distributional baselines and other distributional baselines. Also, the example embodiment may apply its policy to different risk measures without retraining by simply changing a parameter.

According to an example embodiment, it is possible to i) provide a novel navigation algorithm based on distributional RL that may learn a variety of risk-sensitive policies concurrently, ii) provide improved performance over baselines in a plurality of simulation environments, and iii) accomplish generalization to a wide range of risk measures at run-time.

Hereinafter, tasks related to building a model based on an RC-DSAC algorithm and a related technique are described.

A. Risk in Mobile-Robot Navigation

Herein, a deep RL approach may be employed for safe and low-risk robot navigation. To consider a risk, there may be a lot of classical model-predictive-control (MPC) and graph-search approaches. In an example embodiment, in addition thereto, various risks ranging from simple sensor noise and occlusion to uncertainty about the traversability of edges (e.g., doors) of a navigation graph and the unpredictability of pedestrian movements may be considered.

A variety of risk measures ranging from a collision probability used as chance constraints to entropic risk may be explored. In the case of applying a hybrid approach that couples deep learning for pedestrian motion prediction with nonlinear MPC, the hybrid approach may allow risk-metric parameters of a robot to be changed at run-time, which differs from approaches relying on RL. Here, referring to results of the example embodiment, such run-time parameter-tuning may be simply performed for deep RL.

B. Deep RL for Mobile-Robot Navigation

Deep RL is receiving great attention in the field of mobile-robot navigation due to its success in many game and robotics domains. Compared to approaches such as MPC, RL methods are known to be able to infer optimal actions without expensive trajectory predictions and to perform more robustly when cost or reward has local optima.

Also, a deep RL-based method may be proposed that explicitly considers risks arising from uncertainty about an environment. As individual deep networks may make overconfident predictions on far-from-distribution samples, MC-dropout and bootstrapping are applied to predict collision probabilities.

An uncertainty-aware RL method may have an additional observation-prediction model and may use a prediction variance to adjust a variance of actions taken by a policy. Meanwhile, the term “risk reward” may be designed to encourage a safe behavior of an autonomous driving policy, for example, at a lane intersection and switching between two RL-based driving policies may be performed based on the estimated uncertainty about a future pedestrian motion. Although the above method shows promising performance and improved safety in uncertain environments, an additional prediction model, carefully shaped reward functions, or expensive Monte Carlo sampling at run-time may be required.

In contrast to existing works on RL-based navigation, an example embodiment may use distributional RL to learn computationally-efficient risk-sensitive policies without using an additional prediction model or a specifically-tuned reward function.

C. Distributional RL and Risk-Sensitive Policies

Distributional RL may model not a mean of accumulated rewards but a distribution of accumulated rewards. Distributional RL algorithms may depend on the following recursion:

$${Z}^{π} ( s , a ) {=}^{D} r ( s , a ) + γ {Z}^{π} ( {S}^{′} , {A}^{′} ) \qquad [ Equation 1 ]$$

Here, random return Z^{π}(s,a) may be defined as a discounted sum of rewards when starting in state s and taking action a under policy π, notation

$$A {=}^{D} B$$

represents that random variables A and B have an identical distribution, r(s, a) denotes a random reward given a state-action pair, γ∈[0,1) denotes a discount factor, random state S′ follows a transition distribution given (s, a), and random action A′ may be derived from the policy π in random state S′.

Empirically, distributional RL algorithms may demonstrate superior performance and sample efficiency in many game domains since predicting quantiles serves as an auxiliary task that enhances representation learning.

Distributional RL may facilitate learning of risk-sensitive policies. To predict arbitrary quantiles of the distribution of the random return (cumulative reward), and select risk-sensitive actions by estimating various “distortion risk measures” through sampling of quantiles may be learned to extract a risk-sensitive policy. Since sampling needs to be performed for each potential action, the above approach may not be applied to continuous action spaces.

In an example embodiment, a soft actor-critic (SAC) framework may be combined with distributional DL and used to accomplish a task of risk-sensitive control. In robotics, a sample-based distributional policy gradient algorithm may be considered and improved robustness to actuation noise on OpenAI Gym tasks was demonstrated when using coherent risk measures. Meanwhile, distributional RL proposed to learn risk-sensitive policies for grasping tasks may demonstrate superior performance over non-distributional baselines on real-world grasping data.

Despite the impressive performance demonstrated in the existing methods, the existing methods may be limited to learning a policy for a single risk measure at a time. It may be problematic since a desired risk measure may vary depending on an environment and a situation. Therefore, in the following example embodiment, a method of training a single policy that may adapt to various risk measures is described. Hereinafter, an approach of an example embodiment is further described.

In regard to the approach of the example embodiment, a problem formulation and a detailed implementation are described in detail.

A. Problem Formulation

Description is made considering a differential-wheeled robot, for example, an autonomous driving robot, navigating in two dimensions. Referring to FIGS. 7 and 8A and 8B, the robot may be in an octagonal shape and an objective of the robot may be passing a sequence of waypoints without colliding with an obstacle. An environment of FIG. 7 may include an obstacle.

The above problem may be formalized as a partially-observed Markov decision process (POMDP) with sets of states S^{PO}, observations Ω, actions [symbol] , reward function r:S^{PO}× [symbol] → [symbol] , and distributions for an initial state, for state sₜ₊₁∈S^{PO} given state-action (sₜ,aₜ)∈S^{PO}× [symbol] , and for observation oₜ∈Ω given (sₜ, aₜ).

When applying RL, the POMDP may be treated as a Markov decision process (MDP) with set S of states given by episode-histories of the POMDP:

S={(o₀,a₀,o₁,a₁ . . . ,o_{T}):oₜ∈Ω,aₜ∈ [symbol] ,T∈ [symbol] _{≥}0} [Equation 2]

The MDP may have the same action space [symbol] as that of the POMDP and its reward, initial-state, and transition distributions may be implicitly defined by the POMDP. Although it is defined as a function for the POMDP, the reward may be a random variable for the MDP.

1) States and observations: A full state that is a member of the set S^{PO} may be a position of all waypoints that are coupled with positions, velocities, and accelerations of all obstacles. Real-world agents sense only a fraction of the state. For example, an observation may be represented as follows:

(o_{rng},o_{waypoint},o_{velocity})∈ [symbol] ¹⁸⁰× [symbol] ⁶× [symbol] ⁴=:Ω [Equation 3]

The observation may include range-sensor measurements that describe positions of nearby obstacles and information about a position and a velocity of a robot relative to the following two waypoints.

In particular, it may be defined as follows:

o_{rng,i}= [symbol] {dᵢ∈(0.01,3)m}(2.5+log₁₀dᵢ)[Equation 4]

Here, [symbol] {⋅} denotes an indicator function, a denotes a distance in meters to a nearest obstacle in an angular range [2i−2, 2i) degrees relative to an x-axis of a coordinate frame of the robot, and o_{rng,i}=0 if there is no obstacle in a given direction. A waypoint observation may be defined as follows:

o_{waypoint}=[log₁₀ δ₁,cos θ₁,sin θ₁,log₁₀ δ₂,cos θ₂,sin θ₂] [Equation 5]

Here, δ₁, δ₂ denote distances to a next waypoint and a waypoint after the next waypoint, clipped to [0.01, 100] m, and θ₁,θ₂ and denote angles of waypoints relative to the x-axis of the robot. Also, velocity observation o_{velocity}=[ν_{c},θ_{c},νᵤ,ωᵤ] may include current linear and angular velocities ν_{c}, ω_{c} of the robot and desired linear and angular velocities νᵤ, ωᵤ calculated from a previous action of an agent.

2) Actions: Normalized two-dimensional vectors u=(u₀,u₁∈[−1, 1]²=: [symbol] may be used as actions in terms of the desired linear and angular velocities of the robot as follows:

νᵤ=wₘᵢₙᵥ(1−u₀)/2+wₘₐₓᵥ(1+u₀)/2,

ωᵤ= [symbol] {|w_{max ω}u₁|≥15 deg/s}w_{max ω}u₁[Equation 6]

For example, wₘᵢₙᵥ=−0.2 m/s, wₘₐₓᵥ=0.6 m/s, w_{max ω}=90 deg/s.

The desired velocities may be transmitted to a motor controller of the robot and may be clipped to ranges [ν_{c}−w_{accy}Δt, ν_{c}+ω_{accv}Δt] and [ω_{c}−w_{accω}Δt, ν_{c}+ω_{accω}Δt] for maximum accelerations w_{accv}1.5 m/s² and w_{accω}=120 deg/s². Here, Δt=0.02 s denotes a control period of the motor controller. A control period of the agent may be greater than Δt and may be uniformly sampled from {0.12, −0.14, 0.16}s when an episode starts in a simulation and may be 0.15 s in a real-world experiment.

3) Reward: A reward function disclosed herein may encourage the agent to efficiently follow waypoints while avoiding collisions. Omitting dependence on the state and the action for brevity, the reward may be represented as follows:

r=r_{base}+r_{goal}+r_{waypoint}·r_{angular}+r_{coll}. [Equation 7]

Base reward r_{base}=−0.02 may be given at every step to penalize the agent for a time used to reach a goal position (a last waypoint) and r_{goal}=10 may be given when a distance between the agent and the goal position is less than 0.15 m. A waypoint reward may be represented as follows:

r_{waypoint}=max{−0.1,max{0,ν_{c}} cos θ₁} [Equation 8]

Here, θ₁ denotes an angle of a next waypoint relative to the x-axis of the robot and ν_{c} denotes a current linear velocity. r_{waypoint} may be 0 when the agent is in contact with an obstacle.

Reward r_{angular} may encourage navigation of the agent (robot) in a straight line and may be represented as follows:

$${r}_{angular} \{ \begin{matrix}1.2 & if \vert {ω}_{u} \vert < 15 deg / s \\ max \{ 0.5 , 1 - \frac{\vert {ω}_{u} \vert}{( 120 deg / s )} \} & otherwise ,\end{matrix} \qquad [ Equation 9 ]$$

If the agent collides with an obstacle, r_{coll}=−10 may be given.

4) Risk-sensitive objective: As in Equation Z^{π}(s,a) may be a random return given by

$${Z}^{π} ( s , a ) = {\sum }_{t = 0}^{∞} {γ}^{t} r ( S - t , {A}_{t} ) .$$

Here, (Sₜ, Aₜ)_{t∈} [symbol] _{_{≥0}} denotes a random state-action sequence given by the MDP's transition distribution and policy π. Here, γ∈[0,1) denotes a discount factor.

There may be two main approaches to define risk-sensitive decisions. One approach may define a utility function U: [symbol] → [symbol] and may select an action a that maximizes or, alternatively, increases [symbol] U(Z^{π}(s,a)) in state s. Alternatively, one approach may consider a quantile function of Z^{π} defined by Z_{τ}^{π}(s,a):=inf{z∈ [symbol] : [symbol] (Z^{π}(s,a)≤z)≥τ} for quantile fraction τ∈[0,1]. Then, one defines a distortion function that is a mapping ψ: [0,1]->[0,1] from quantile fractions to quantile fractions and may select an action a that maximizes or, alternatively, increases a distortion risk measure [symbol] _{τ˜U([0,1])}Z_{ψ(τ)}^{π}(s,a) in the state s.

In this work, two distortion risk measures each with a scalar parameter [symbol] corresponding to a risk-measure parameter may be considered. One of them may be a widely used conditional value-at-risk (CVaR), which is an expectation of a fraction [symbol] of least-favorable random returns and may correspond to the following distortion function:

ψ^{CVaR}(τ;β):=βτ for β∈(0,1] [Equation 10]

Lower [symbol] may result in a more risk-averse policy and [symbol] =1 may represent a risk-neutral policy.

The other one may be a power-law risk measure, given by the following distortion function:

ψ^{pow}(τ;β):=1−(1−τ)^{1/(1-β)} for β<0 [Equation 11]

The distortion function may be motivated by good performance in a grasping experiment. For the given parameter ranges, both risk measures may be coherent.

That is, the aforementioned risk-measure parameter ( [symbol] ) may refers to a parameter that represents a CVaR risk measure and be a number within the range greater than 0 or less than or equal to 1, or may refer to a parameter that represents a power-law risk measure and be a number within the range less than 0. In learning of the model, [symbol] may be sampled from the above range and used.

The above Equation 10 and Equation 11 may relate to distorting the probability distribution, that is, the reward distribution according to [symbol] .

B. Risk-Conditioned Distributional Soft Actor-Critic (RC-DSAC)

To efficiently learn a wide range of risk-sensitive policies, an RC-DSAC algorithm may be proposed.

1) Soft actor-critic (SAC) algorithm: An algorithm of an example embodiment is based on the SAC algorithm. Here, the term “soft” may represent entropy-regularized. SAC may maximize or, alternatively, increase accumulated rewards and entropy of the policy jointly:

$$J ( π ) = {𝔼}_{π} [ {\sum }_{t = 0}^{∞} {γ}^{t} [ r ( {s}_{t} , {a}_{t} ) + α H ( π ( \cdot \vert {s}_{t} ) ) ] ] \qquad [ Equation 12 ]$$

Here, the expectation may be over state-action sequences given by the policy π and transition distribution, α∈ [symbol] _{≥0} denotes a temperature parameter that trades-off an optimization of reward and entropy, and H(p(⋅)):=− [symbol] _{a˜p(a)} log p(a) denotes entropy of a distribution over actions assumed to have a probability density p(⋅).

SAC may have a critic network that learns a soft state-action value function Q^{π}:S× [symbol] → [symbol] , using a soft Bellman operator of the following Equation 13:

T^{π}Q^{π}(sₜ,aₜ):= [symbol] _{π}[r(sₜ,aₜ)+γ(Q^{π}(sₜ₊₁,aₜ₊₁)−α log π(aₜ₊₁|sₜ₊₁))|sₜ,aₜ] [Equation 13]

Also, SAC may have an actor network that minimizes or, alternatively, reduces Kullback-Leibler divergence between a policy and a distribution given by an exponential of a soft value function of the following Equation 14:

$${π}_{new} = {arg min}_{{π}^{′} ∈ \prod } {𝔼}_{s \sim {𝒟}^{{π}_{old}}} [ {D}_{KL} ( {π}^{′} ( \cdot \vert s ) \vert \vert \frac{{e}^{\frac{{Q}^{{π}_{old} ( s , \cdot )}}{α}}}{{Z}_{part}^{{π}_{old}} ( s )} ) ] \qquad [ Equation 14 ]$$

Here, Π denotes a set of policies that may be represented by the actor network, [symbol] ^{π} denotes a distribution over states induced by the policy π and transition distribution, which may be approximated in practice by an experience replay, and Z_{part.}^{π}^{_{old}}(sₜ) denotes a partition function that normalizes the distribution.

In practice, a reparameterization trick may be often used. In this case, SAC may sample actions as aₜ=f(sₜ,ϵₜ). Here, f(⋅,⋅) denotes a mapping implemented by the actor network and ϵₜ denotes a sample from a fixed distribution like a spherical Gaussian N. A policy objective may have a form of the following Equation 15:

J(π)= [symbol] [Q(s,f(s,ϵ))−α log π(f(s,ϵ)|s)] [Equation 15]

2) Distributional SAC and risk-sensitive policies: To capture a full distribution of accumulated rewards rather than just a mean thereof, the proposed distributional SAC (DSAC) may be used. The DSAC may use a quantile regression method to learn the distribution.

Rather than using the random return Z^{π} of the above Equation 1, DSAC may use a soft random return appearing in Equation 12, given by

$${Z}^{α , π} ( s , a ) := {\sum }_{t = 0}^{∞} {γ}^{t} [ r ( {S}_{t} , {A}_{t} ) - α log π ( {A}_{t} \vert {S}_{t} ) ) ] .$$

Here, (Sₜ,Aₜ)_{t∈Z}_{_{≥0}} as in Equation 1. Similar to the SAC algorithm, the DSAC algorithm may have an actor and a critic.

To train the critic, some quantile fractions τ₁, . . . , τ_{N} and τ₁′, . . . , τ_{N}′, may be independently sampled and the critic may minimize or, alternatively, reduce a loss as follows:

$$L ( {s}_{t} , {a}_{t} , {r}_{t} , {s}_{t + 1} ) = \frac{1}{{N}^{′}} {\sum }_{i = 1}^{N} {\sum }_{i = 1}^{{N}^{′}} {ρ}_{{τ}_{i}} ( {δ}_{t}^{{τ}_{i} , {τ}_{j}^{′}} ) \qquad [ Equation 16 ]$$

Here, for x∈ [symbol] , a quantile regression loss may be represented as follows:

ρ_{τ}(x)=|τ− [symbol] {x<0}|min{x²,2|x|−1}/2 [Equation 17]

A temporal difference may be represented as follows:

δₜ^{τ,τ′}=rₜ+γ[\hat{Z}_{τ′}′(sₜ₊₁,aₜ₊₁)−α log π(aₜ₊₁|sₜ₊₁)]−\hat{Z}_{τ}(sₜ,aₜ) [Equation 18]

Here, (sₜ, aₜ, rₜ, sₜ₊₁) denotes a transition from a replay buffer, \hat{Z}_{τ}(s,a) denotes an output of the critic that is an estimate of τ-quantile of Z^{α,π}(s,a), and \hat{Z}_{τ′}′(s,a) denotes an output of a delayed version of the critic known as a) target critic.

To train a risk-sensitive actor network, the DSAC algorithm may use a distortion function ψ. Rather than directly maximizing a corresponding risk measure, the DSAC algorithm may substitute Q(s,a)= [symbol] _{τ˜U([0,1])}Z_{ψ(τ)}(s,a) in Equation 15. Here, [symbol] denotes an average of a sample.

3) Risk-conditioned DSAC: Although risk-sensitive policies learned by the DSAC algorithm demonstrate promising results in a plurality of simulation environments, the DSAC algorithm aforementioned in 2) may learn only one type of risk-sensitive policy at a time. This may be problematic for mobile-robot navigation if an appropriate risk measure parameter differs depending on an environment and a user desires to tune the parameter.

To treat the above issue, an example embodiment may use the RC-DSAC algorithm, which extends the DSAC algorithm to learn a wide range of risk-sensitive policies concurrently and may change its risk-measure parameter without performing a retraining process.

The RC-DSAC algorithm may learn risk-adaptable policies for a distortion function ψ(⋅;β) with the parameter [symbol] , by providing [symbol] as an input to the policy π(⋅|s,β), the critic \hat{Z}_{τ}(s,a;β), and the target critic \hat{Z}_{τ′}′(s,a;β). In detail, the objective of the critic of Equation 16 may be represented as follows:

$$L ( {s}_{t} , {a}_{t} , {r}_{t} , {s}_{t + 1} , β ) = \frac{1}{{N}^{′}} {\sum }_{i = 1}^{N} {\sum }_{i = 1}^{{N}^{′}} {ρ}_{{τ}_{i}} ( {δ}_{t}^{{τ}_{i} , {τ}_{j}^{′} , β} ) \qquad [ Equation 19 ]$$

Here, ρ_{τ}(⋅) may be as in Equation 17 and the temporal difference may be represented as follows:

δₜ^{τ,τ′}=rₜ+γ[\hat{Z}_{τ′}′(sₜ₊₁,aₜ₊₁;β)−α log π(aₜ₊₁|sₜ₊₁,β)]−\hat{Z}_{τ}(sₜ,aₜ;β) [Equation 20]

The objective of the actor of Equation 15 may be represented as follows:

J(π)= [symbol] [Q(s,f(s,ϵ,β);β)−α log π(f(s,ϵ,β)|s)] [Equation 21]

Here, Q(s,a;β)= [symbol] _{τ˜U([0,1])}\hat{Z}_{ψ(τ;β)}(s,a;β) and [symbol] denotes a distribution for sampling β.

During training, the risk-measure parameter [symbol] may be uniformly sampled from [symbol] =U([0,1]) for ψ^{CVaR} and from U([−2, 0]) for ψ^{pow}.

Similar to other RL algorithms, each iteration may include a data collection phase and a model update phase. In the data collection phase, [symbol] may be sampled at the start of each episode and may be fixed until a corresponding episode ends. In the model update phase, the following two alternatives may be applied. A first alternative called ‘stored’ may store [symbol] used in data collection and only the stored [symbol] may be used for update. A second alternative called ‘resampling’ may sample a new [symbol] for each experience in a mini batch at every iteration (resampling).

That is, the learning model described above with reference to FIGS. 1 to 5 may learn a distribution of rewards by iterating estimation of a reward according to an action of a device, for example, a robot, for a situation. Here, each iteration may include learning of each episode representing a movement from a starting position to a goal position of the device, for example, the robot, and updating of the learning model. An episode may represent a sequence of a state, an action, and a reward through which an agent passes from a source state (a starting position) to a final state (a goal position). When each episode starts, a risk-measure parameter ( [symbol] ) may be sampled (e.g., randomly) and the sampled risk-measure parameter ( [symbol] ) may be fixed until each episode ends.

Updating of the learning model may be performed using the sampled risk-measure parameter, stored in a buffer, for example, an experience-replay buffer, of the computer system 100. For example, the update phase of the learning model may be performed using the previously sampled risk-measure parameter (stored). That is, [symbol] used in the data collection phase may be reused for the updating stage of the learning model.

Alternatively, the computer system 100 may resample the risk-measure parameter when performing the update phase and may perform the update phase of the learning model using the resampled risk-measure parameter (resampling). That is, [symbol] used in the data collection phase may be reused in the update phase of the learning model and [symbol] may be resampled in the update phase of the learning model.

4) Network architecture: τ and [symbol] may be represented using a cosine embedding and an element-wise multiplication may be used to fuse τ and [symbol] with information about observation and quantile fraction as shown in FIG. 6.

FIG. 6 illustrates an example of an architecture of the learning model described above with reference to FIGS. 1 to 5. Referring to FIG. 6, a model architecture may be an architecture of networks used in RC-DSAC. A model 600 may be a model that constitutes the aforementioned learning model. FC included in the model 600 denotes a fully connected layer. Cony 1D denotes a one-dimensional convolutional layer with a given number of channels/kernel_size/stride. GRU denotes a gated recurrent unit. A plurality of arrows pointing a single block represents a concatenation and ⊙ denotes an element-wise multiplication.

As in the DSAC algorithm, a critic network (i.e., a critic model) of the RC-DSAC algorithm according to an example embodiment may depend on τ. However, both an actor network (i.e., an actor model) and the critic network of the RC-DSAC algorithm according to the example embodiment may depend on [symbol] . Therefore, embeddings with elements ϕ^{β}∈ [symbol] ⁶⁴, ϕ^{τ}∈ [symbol] ⁶⁴ with elements ϕᵢ^{β}=cos(πiβ) and cos(πiτ) may be calculated.

Then, the element-wise multiplication g^{actor}(o_{0:t})⊙g^{actorRisk}(ϕ^{β}) may be applied to the actor network and may be g^{critic}(o_{0:t},uₜ)⊙g^{criticRisk}([ϕ^{β};ϕ^{τ}]) may be applied to the critic network. Here, g^{actor}(o_{0:t}),g^{critic}(o_{0:t},uₜ)∈ [symbol] ¹²⁸ denote embeddings of observation history and a current action for the critic calculated using GRU, and g^{actorRisk}: [symbol] ⁶⁴→ [symbol] ¹²⁸ and g^{criticRisk}: [symbol] ¹²⁸→ [symbol] ¹²⁸ denote fully connected layers, and [ϕ^{β}; ϕ^{τ}] denotes a concatenation of vectors ϕ^{β} and ϕ^{τ}.

That is, the learning model described above with reference to FIGS. 1 to 5 may include a first model (corresponding to the aforementioned actor model) configured to predict an action of a device, for example, a robot, and a second model (corresponding to the aforementioned critic model) configured to predict a reward according to the predicted action. The model 600 of FIG. 6 may correspond to one of the first model and the second model. Here, a block representing an output end may be differently configured for the first model and the second model.

Referring to FIG. 6, an action (u) (e.g., an action predicted by the first model (the actor model)) predicted to be performed for a situation may be input to the second model and the second model may estimate a reward according to the action (u) (e.g., corresponding to the aforementioned reward Q). That is, in the model 600, a block of u (for the critic) may be applied only to the second model.

The first model may be trained to predict an action that maximizes or, alternatively, increases the reward predicted from the second model as a next action of the device. That is, the first model may be trained to predict an action that maximizes or, alternatively, increases the reward among actions for the situation as an action, that is, a next action, for the situation. Here, the second model may be trained to learn the reward, for example, a reward distribution, according to the determined next action, which may be used again to determine an action in the first model.

Each of the first model and the second model may be trained using a risk-measure parameter ( [symbol] ) ( [symbol] (for actor) and [ [symbol] ; ϕ^{τ}] (for critic) in FIG. 6).

That is, both the first model and the second model may be trained using the risk-measure parameter ( [symbol] ). Therefore, although various risk-measure parameters are set, the implemented learning model may determine, for example, estimate an action of the device adaptable to a corresponding risk measure without performing a model retraining process.

When the device is an autonomous driving robot, the aforementioned first model and second model may predict an action and a reward of the device, respectively, based on a position o_{rng} of an obstacle around the robot, a path o_{waypoints} through which the robot is to move, and a velocity o_{velocity} of the robot. Here, the path o_{waypoints} through which the robot is to move may represent a next waypoint (e.g., a position of a corresponding waypoint) to which the robot is to move. o_{rng}, o_{waypoints}, and o_{velocity} may be input to the first/second model as encoded data. The aforementioned description in A. Problem formulation may be applied to o_{rng}, o_{waypoints}, and o_{velocity}.

In an example embodiment, the first model (i.e., the actor model (the actor network)) may be trained to receive (e.g., randomly sampled) [symbol] and distort a reward distribution for the action (policy), and to determine an action (policy) (e.g., a risk-averse action or a risk-seeking action) that maximizes or, alternatively, increases a reward in the distorted reward distribution.

The second model (i.e., the critic model (the critic network)) may be trained using a cumulative reward distribution τ when the device acts according to the action (policy) determined by the first model. Alternatively, the first model may be trained using the cumulative reward distribution by further considering (e.g., randomly sampled) [symbol] .

The first model and the second model may be concurrently trained. Therefore, when the first model is trained to maximize or, alternatively, increase a reward, the second model may be updated accordingly (as the reward distribution is updated).

The learning model built according to an example embodiment (i.e., built by including the first model and the second model) may not require a retraining process although [symbol] input to the learning model is changed based on a setting of the user and the action (policy) according to the distorted reward distribution may be immediately determined in correspondence to the input [symbol] .

Hereinafter, a simulation environment used for training is described and a method of an example embodiment is compared to baselines and a trained policy is demonstrated using a real-world robot.

FIG. 7 illustrates an example of an environment of a simulation for training a learning model according to at least one example embodiment, and FIGS. 8A and 8B illustrate examples of setting a sensor of a device, for example, a robot 700 used in a simulation for training a learning model according to at least one example embodiment. In FIG. 8A, a field of view of the sensor of the robot 700 is set to be narrow as is illustrated by narrow field of view 810. In FIG. 8B, the field of view of the sensor of the robot 700 is set to be sparse as is illustrated by sparse field of view 820. That is, the robot 700 may have a limited field of view without covering a 360-degree field of view.

A. Training Environment

Referring to FIG. 7, dynamics of the robot 700 may be simulated. 10 simulations may be run in parallel to increase a throughput of data collection. In detail, for each environment generated, 10 episodes may be run in parallel. Here, the episodes may involve agents with distinct start and goal positions and distinct risk-metric parameters β. Each episode may end after 1000 steps and a new goal may be sampled when an agent reaches a goal.

To study the impact of partial observation on the method of the example embodiment, two different sensor configurations of FIGS. 8A and 8B may be used.

B. Training Agents

Performance of RC-DSAC of the example embodiment may be compared to performance of SAC and DSAC. Also, comparison is performed to a reward-component-weight randomization (RCWR) method applied to a reward function of the example embodiment.

Two RC-DSAC agents are trained and may correspond to distortion functions ψ^{CVaR} and ψ^{pow}, respectively. Then, the RC-DSAC agent with ψ^{CVaR} may be evaluated for β∈{0.25, 0.5, 0.75, 1} and the RC-DSAC agent with ψ^{pow} may be evaluated for β∈{−2, −1.5, −1, −0.5}.

For DSAC agents, ψ^{CVaR} with β∈{0.25, 0.75} and ψ^{pow} with β∈{−2, −1} may be used. Each of the DSAC agents may be trained and evaluated for a single β. For RCWR agents, only a single navigation parameter w_{coll}˜U([0.1, 2]) may be used.

When calculating a reward r, a reward r_{coll} may be replaced by ω_{coll}r_{coll} with higher values of ω_{coll} n making an agent more collision-averse while still remaining risk-neutral. w_{coll}∈{1, 1.5, 2} may be used for evaluation.

All baselines may use the same network architecture as that of RC-DSAC with the following exceptions. DSAC may not use g^{actorRisk} and g^{criticRisk} may depend only on ϕ^{τ}. RCWR may have an extra 32-dimensional fully connected layer in its observation encoder for w_{coll}. Also, RCWR and SAC may not use g^{actorRisk} and g^{criticRisk}.

Hyperparameters for all algorithms are shown in the following Table 1.

TABLE 1

| Parameter | Value |
|---|---|
| Learning rate | 3 × 10⁻⁴ |
| Discount factor (γ) | 0.99 |
| Target network | 0.001 |
| update coefficient | |
| Entropy target | −2 |
| Quantile fraction | 16 |
| samples (N, N′) | |
| Experience replay | 5 × 10⁶ |
| buffer size | |
| Mini-batch size | 100 |
| GRU unroll | 64 |

Each algorithm may be trained for 100,000 weight updates (5,000 episodes in 500 environments). Then, the algorithms may be evaluated on 50 environments not seen in training. 10 episodes may be evaluated per environment with agents having distinct start and goal positions but having a common value for [symbol] or ω_{coll}.

To ensure fairness and reproducibility, fixed random seeds may be used for training and evaluation. Therefore, different algorithms may be trained and evaluated on exactly the same sequences of environments and start/goal positions.

C. Performance Comparison

Table 2 shows a mean and a standard deviation of a number of collisions and a reward of each method, averaged over the 500 episodes across the 50 evaluation environments.

TABLE 2

| | | | Narrow | | Sparse | |
|---|---|---|---|---|---|---|
| Agent | ψ | β | Collisions | Rewards | Collisions | Rewards |
| RC- | CVaR | 0.25 | 0.67 ± 2.03 | 403.9 ± 186.2 | 0.19 ± 0.48 | 487.8 ± 88.2 |
| DSAC | | 0.5 | 0.59 ± 1.03 | 451.3 ± 125.4 | 0.29 ± 0.62 | 512.0 ± 54.8 |
| (re- | | 0.75 | 0.81 ± 1.75 | 452.0 ± 145.9 | 0.42 ± 0.93 | 507.6 ± 65.1 |
| sample) | | 1 | 1.15 ± 2.48 | 458.8 ± 140.3 | 0.55 ± 1.03 | 505.2 ± 60.1 |
| | pow | −2 | 0.05 ± 0.84 | 509.4 ± 99.2 | 0.21 ± 0.68 | 473.4 ± 113.9 |
| | | −1.5 | 0.48 ± 0.89 | 511.7 ± 98.8 | 0.17 ± 0.53 | 479.0 ± 107.4 |
| | | −1 | 0.58 ± 1.36 | 514.7 ± 96.4 | 0.21 ± 0.58 | 482.2 ± 101.9 |
| | | −0.5 | 0.68 ± 1.18 | 506.7 ± 113.3 | 0.23 ± 0.75 | 488.3 ± 104.2 |
| RC- | CVaR | 0.25 | 0.68 ± 3.47 | 443.5 ± 168.3 | 0.37 ± 0.68 | 494.7 ± 89.3 |
| DSAC | | 0.5 | 1.00 ± 5.14 | 397.7 ± 173.2 | 0.38 ± 0.08 | 499.4 ± 87.8 |
| (stored) | | 0.75 | 1.10 ± 2.27 | 431.0 ± 152.3 | 0.39 ± 0.77 | 501.0 ± 86.0 |
| | | 1 | 1.59 ± 8.09 | 298.4 ± 246.9 | 1.00 ± 1.63 | 477.7 ± 97.6 |
| | pow | −2 | 0.87 ± 3.90 | 465.0 ± 151.6 | 0.42 ± 0.72 | 492.3 ± 84.5 |
| | | −1.5 | 0.73 ± 2.11 | 471.4 ± 130.0 | 0.68 ± 1.32 | 468.4 ± 335.8 |
| | | −1 | 1.13 ± 3.40 | 460.1 ± 122.2 | 0.58 ± 0.96 | 504.5 ± 80.6 |
| | | −0.5 | 0.95 ± 3.30 | 459.1 ± 122.9 | 1.12 ± 1.52 | 496.7 ± 84.0 |
| DSAC | CVar | 0.25 | 1.05 ± 1.75 | 431.9 ± 127.6 | 0.76 ± 1.18 | 417.2 ± 117.8 |
| | | 0.75 | 0.72 ± 3.00 | 299.6 ± 199.2 | 0.63 ± 1.03 | 515.4 ± 74.1 |
| | pow | −2 | 1.14 ± 4.02 | 469.2 ± 212.6 | 0.54 ± 1.29 | 525.5 ± 76.8 |
| | | −1 | 0.73 ± 2.57 | 499.4 ± 115.7 | 0.08 ± 1.80 | 513.3 ± 84.5 |

| | | | | | |
|---|---|---|---|---|---|
| RCWR | w_{coll} = 2 | 1.58 ± 2.68 | 488.2 ± 122.5 | 0.81 ± 1.08 | 506.1 ± 81.1 |
| | w_{coll} = 1.5 | 1.50 ± 2.39 | 491.7 ± 108.8 | 1.17 ± 1.71 | 491.9 ± 101.2 |
| | w_{coll} = 1 | 1.60 ± 2.55 | 493.7 ± 116.7 | 1.23 ± 1.59 | 490.8 ± 93.5 |
| SAC | — | 1.76 ± 2.20 | 476.7 ± 105.4 | 1.62 ± 2.48 | 491.8 ± 103.5 |

Referring to Table 2, the RC-DSAC agent with ψ^{pow} and β=−1 had the highest rewards in the narrow setting and the RC-DSAC agent with ψ^{pow} and β=−1.5 had the fewest collisions in both settings.

Risk-sensitive algorithms (DSAC, RC-DSAC) all had fewer collisions than SAC and some of the risk-sensitive algorithms had achieved the fewer collisions while attaining a higher reward. Also, results for RCWR may suggest that distributional risk-aware approaches may be more effective than simply increasing the penalty for collisions.

Although DSAC is compared to two alternative implementations of RC-DSAC by averaging over both risk measures, comparison is performed only for two values of β on which DSAC was evaluated. In the narrow setting, RC-DSAC (stored) had a comparable number of collisions (0.95 vs. 0.91) but higher rewards (449.9 vs. 425.0) than DSAC. In the sparse setting, RC-DSAC (stored) had fewer collisions (0.44 vs. 0.68) but comparable rewards (498.1 vs. 492.9). Overall, RC-DSAC (resampling) had the fewest collisions (0.64 in the narrow setting and 0.26 in the sparse setting) and attained the highest rewards (470.0) in the narrow setting. This shows the ability of the algorithm of the example embodiment to adapt to a wide range of risk-measure parameters without retraining required by DSAC.

Also, a number of collisions made by RC-DSAC may represent a clear positive correlation with β for the CVaR risk measure, which may be expected as low β corresponds to risk aversion.

D. Real-World Experiments

To implement the methods of the example embodiment in the real world, a mobile-robot platform as shown in FIG. 5 may be built. The robot 500 may include, for example, four depth cameras on its front and point cloud data from such sensors may be mapped to observation o_{rng} corresponding to the narrow setting. RC-DSAC (resampling) and baseline agents may be deployed for the robot 500.

For each agent, two experiments were run in a course with a length of 53.8 m, making a run forward and another in the reverse direction and results thereof are shown in the following Table 3.

TABLE 3

| | | | Forward | | Reverse | |
|---|---|---|---|---|---|---|
| | | | | Required | | Required |
| Agent | ψ | β | Collision | Time (s) | Collision | Time (s) |
| RC-DSAC | CVaR | 0.25 | 0 | 107 | 0 | 114 |
| | | 0.75 | 0 | 112 | 1 | 109 |
| | pow | −2 | 0 | 110 | 0 | 116 |
| | | −1 | 0 | 107 | 1 | 107 |
| DSAC | CVaR | 0.25 | 0 | 141 | 0 | 128 |
| | | 0.75 | 0 | 104 | 0 | 114 |
| | pow | −2 | 0 | 109 | 0 | 104 |
| | | −1 | 0 | 111 | 0 | 104 |
| SAC | — | — | 3 | 115 | 2 | 111 |

Table 3 shows a number of collisions and a required time to reach a goal position for each agent. Referring to Table 3, SAC had more collisions than distributional risk-averse agents.

DSAC had no collisions throughout the experiments, but showed over-conservative behavior and used a longest time to reach the goal position (with ψ^{CVaR} and [symbol] =0.25). RC-DSAC performed competitively with DSAC except minor collisions in less risk-averse modes and was able to adapt its behavior according to [symbol] . Therefore, it may be verified that, through the proposed RC-DSAC algorithm, superior performance adaptivity to a change of the risk measure according to a change of [symbol] may be achieved.

That is, the model that adopts the RC-DSAC algorithm of the example embodiment may demonstrate superior performance over comparable baselines and may have adjustable risk-sensitiveness. The model that adopts the RC-DSAC algorithm may be applied to a device including a robot and thereby maximize or, alternatively, increase utility.

The apparatuses described above may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software. Examples of a program instruction may include a machine language code produced by a compiler and a high-language code executable by a computer using an interpreter.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A method of determining an action of a device for a given situation, implemented by a computer system, the method comprising:
for a learning model that learns a distribution of rewards according to the action of the device for the situation using a risk-measure parameter associated with control of the device, selectively setting a value of the risk-measure parameter in accordance with an environment in which the device is controlled; and
determining the action of the device for the given situation when controlling the device in the environment, based on the set value of the risk-measure parameter.

2. The method of claim 1, wherein the determining of the action of the device comprises determining the action of the device to be more risk-averse or risk-seeking for the given situation based on the set value of the risk-measure parameter or a range indicated by the set value of the risk-measure parameter.

3. The method of claim 2, wherein the device is an autonomous driving robot, and
the determining of the action of the device comprises determining run-forward or acceleration of the robot as a more risk-seeking action of the robot if the value of the risk-measure parameter is greater than or equal to a desired value or if the set value of the risk-measure parameter is greater than or equal to a desired range.

4. The method of claim 1, wherein the learning model learns the distribution of rewards obtainable according to the action of the device for the situation using a quantile regression method.

5. The method of claim 4, wherein the learning model learns values of the rewards corresponding to first parameter values that belong to a first range, samples the risk-measure parameter that belongs to a second range corresponding to the first range and learns a value of a reward corresponding to the sampled risk-measure parameter in the distribution of rewards, and
a minimum value among the first parameter values corresponds to a minimum value among the values of the rewards and a maximum value among the first parameter values corresponds to a maximum value among the values of the rewards.

6. The method of claim 5,
wherein the first range is 0-1 and the second range is 0-1, and
wherein the risk-measure parameter belonging to the second range is randomly sampled at a time of learning of the learning model.

7. The method of claim 5,
wherein each of the first parameter values represents a percentage position, and
wherein each of the first parameter values corresponds to a value of a corresponding reward at a corresponding percentage position.

8. The method of claim 1,
wherein the learning model comprises:
a first model configured to predict the action of the device for the situation; and
a second model configured to predict a reward according to the predicted action,
wherein each of the first model and the second model is trained using the risk-measure parameter, and
wherein the first model is trained to predict an action that maximizes the reward predicted from the second model as a next action of the device.

9. The method of claim 8,
wherein the device is an autonomous driving robot, and
wherein the first model and the second model are configured to predict the action of the device and the reward, respectively, based on a position of an obstacle around the robot, a path through which the robot is to move, and a velocity of the robot.

10. The method of claim 1,
wherein the learning model learns the distribution of rewards by iterating estimating of the reward according to the action of the device for the situation,
wherein each iteration comprises learning each episode that represents a movement from a start position to a goal position of the device and updating the learning model, and
wherein, when each episode starts, the risk-measure parameter is sampled and the sampled risk-measure parameter is fixed until a corresponding episode ends.

11. The method of claim 10, wherein updating of the learning model is performed using the sampled risk-measure parameter that is stored in a buffer, or performed by resampling the risk-measure parameter and using the resampled risk-measure parameter.

12. The method of claim 1, wherein the risk-measure parameter is a parameter representing a conditional value-at-risk (CVaR) risk measure that is a number within a range greater than 0 and less than or equal to 1, or a power-law risk measure that is a number within the range less than zero.

13. The method of claim 1,
wherein the device is an autonomous driving robot, and
wherein the setting of the risk-measure parameter comprises setting the value of the risk-measure parameter to the learning model based on a value requested by a user while the robot is autonomously driving in the environment.

14. A non-transitory computer-readable record medium storing computer-executable instructions that, when executed by a processor, cause the processor to perform the method of claim 1.

15. A computer system comprising:
memory storing computer-executable instructions; and
at least one processor configured to execute the computer-executable instructions such that the at least one processor is configured to,
for a learning model that learns a distribution of rewards according to an action of a device for a situation using a risk-measure parameter associated with control of the device, selectively set a value of the risk-measure parameter in accordance with an environment in which the device is controlled, and
determine the action of the device for the situation when controlling the device in the environment, based on the set value of the risk-measure parameter.

16. A method of training a model used to determine an action of a device for a situation, the method comprising:
training, by a processor, the model to learn a distribution of rewards according to the action of the device for the situation using a risk-measure parameter associated with control of the device such that,
the trained model includes a risk-measure parameter that is capable of being selectively set according to a characteristic of an environment, and
as the risk-measure parameter of the trained model is set for the environment in which the device is controlled, the trained model determines the action of the device for the situation based on the set risk-measure parameter through the model when the device is being controlled in the environment.

17. The method of claim 16, wherein the training comprises training the model to learn the distribution of rewards obtainable according to the action of the device for the situation using a quantile regression method.

18. The method of claim 17,
wherein the training comprises:
training the model to learn values of the rewards corresponding to first parameter values that belong to a first range,
sampling the risk-measure parameter that belongs to a second range corresponding to the first range; and
learning a value of a reward corresponding to the sampled risk-measure parameter in the distribution of rewards, and
wherein a minimum value among the first parameter values corresponds to a minimum value among the values of the rewards and a maximum value among the first parameter values corresponds to a maximum value among the values of the rewards.

19. The method of claim 16,
wherein the trained model comprises:
a first model configured to predict the action of the device for the situation; and
a second model configured to predict a reward according to the predicted action,
wherein each of the first model and the second model is trained using the risk-measure parameter, and
wherein the training comprises training the first model to predict an action that maximizes the reward predicted from the second model as a next action of the device.

20. The method of claim 2, wherein the device is an autonomous driving robot, and
the determining of the action of the device comprises:
selecting, as the determined action, an action that causes the device to operate in a more risk-seeking manner as the set value of the risk-measure parameter becomes a more risk-seeking value, and
selecting, as the determined action, an action that causes the device to operate in a more risk-averse manner as the set value of the risk-measure parameter becomes a more risk-averse value.
